(19) United States
(12) Patent Application Publication
(10) Pub. No.: US 2006/0092276 A1
(43) Pub. Date: May 4, 2006

(54) Inspection system and method for identifying surface and body defects in a glass sheet

(76) Inventors: James A. Ariglio, Painted Post, NY (US); Ted A. Brownlee, Livermore, CA (US); David C. Darrow, Pleasanton, CA (US); Vincent W. Howell, Horseheads, NY (US); Sergey Potapenko, Livermore, CA (US); Patrick Sullivan, Pleasanton, CA (US); Peter M. Voit, Dublin, CA (US)

Correspondence Address: CORNING INCORPORATED, SP-TI-3-1, CORNING, NY, 14831, US

(21) Appl. No.: 10/977,514

(22) Filed: Oct. 28, 2004

(51) Int. Cl. H04N 7/18; H04N 9/47

(52) U.S. Cl. 348/132

(57) ABSTRACT

An inspection system and method are described herein which use an illuminating system (e.g., light source (strobe) and light sharpening components) and an imaging system (e.g., digital camera and computer/software) to inspect and identify surface and body defects in a glass sheet (e.g., liquid crystal display (LCD) glass substrate).

### BACKGROUND OF THE INVENTION

1. Field of the Invention

The present invention relates in general to an inspection system and method for identifying defects (e.g., scratches, particles, air bubbles) on a surface or within a body of a glass sheet (e.g., liquid crystal display (LCD) glass substrate).

2. Description of Related Art

A traditional inspection system used in industry today includes an analog camera and a strobe light that work together to help identify defects (e.g., scratches, particles, air bubbles) on a surface or within a body of a glass sheet. Typically, the strobe light emits light that illuminates a portion of the glass sheet while the analog camera located on the other side of the glass sheet takes a picture of the illuminated portion of the glass sheet. The picture is then analyzed to determine if there are any defects on that portion of the glass sheet. To inspect the entire glass sheet, the glass sheet and/or the strobe light/analog camera need to be moved in one way or another so that the analog camera can take enough pictures to create a macro image map of the entire glass sheet. There are several drawbacks with using the traditional inspection system. First, the analog camera has a relatively small field of view (e.g., 12 mm×16 mm) which means that multiple pictures need to be taken to create a macro image map of the glass sheet which in turn means it takes longer to inspect the entire glass sheet. Secondly, the strobe light's illumination is limited which makes it difficult to obtain the proper intensity and uniformity of light needed at the glass sheet so the analog camera can take a picture that indicates the defects of the glass sheet. Accordingly, there is a need for a new inspection system that addresses the aforementioned shortcomings and other shortcomings of the traditional inspection system. This need and other needs are satisfied by the inspection system and method of the present invention.

### BRIEF DESCRIPTION OF THE INVENTION

The present invention includes a method and an inspection system which uses an illuminating system (e.g., light source (strobe) and light sharpening components) and an imaging system (e.g., digital camera and computer/software) to inspect and identify surface and body defects in a glass sheet (e.g., liquid crystal display (LCD) glass substrate). In the preferred embodiment, the illuminating system includes a strobe light for emitting light and a spherical reflector and a main reflector both of which reflect a portion of the emitted light. The illuminating system also includes a darkfield patch for blocking a portion of the emitted and reflected light and a diffuser for diffusing the emitted and reflected light that was not blocked by the darkfield patch. The illuminating system further includes a conical snoot for eliminating glare in the camera objective by blocking the portion of the light from reaching the camera lens without scattering on the glass defects. Then, the imaging system and in particular the digital camera that is located on the other side of the glass sheet acquires an image that is analyzed by the computer to determine whether or not there are defects in the illuminated portion of the glass sheet.

### BRIEF DESCRIPTION OF THE DRAWINGS

A more complete understanding of the present invention may be had by reference to the following detailed description when taken in conjunction with the accompanying drawings wherein:

FIG. 1 is a diagram illustrating the basic components of an inspection system in accordance with the present invention;

FIG. 2 is a perspective view of an illuminating system which is part of the inspection system shown in FIG. 1;

FIG. 3 is a perspective view of a mounting assembly used to secure a strobe light of the illuminating system shown in FIG. 2;

FIG. 4 is a perspective view of a spherical reflector used in the illuminating system shown in FIG. 2;

FIG. 5 is a perspective view of a main reflector used in the illuminating system shown in FIG. 2; and

FIG. 6 is a flowchart illustrating the basic steps of a preferred method for identifying surface and body defects in a glass sheet in accordance with the present invention.

### DETAILED DESCRIPTION OF THE DRAWINGS

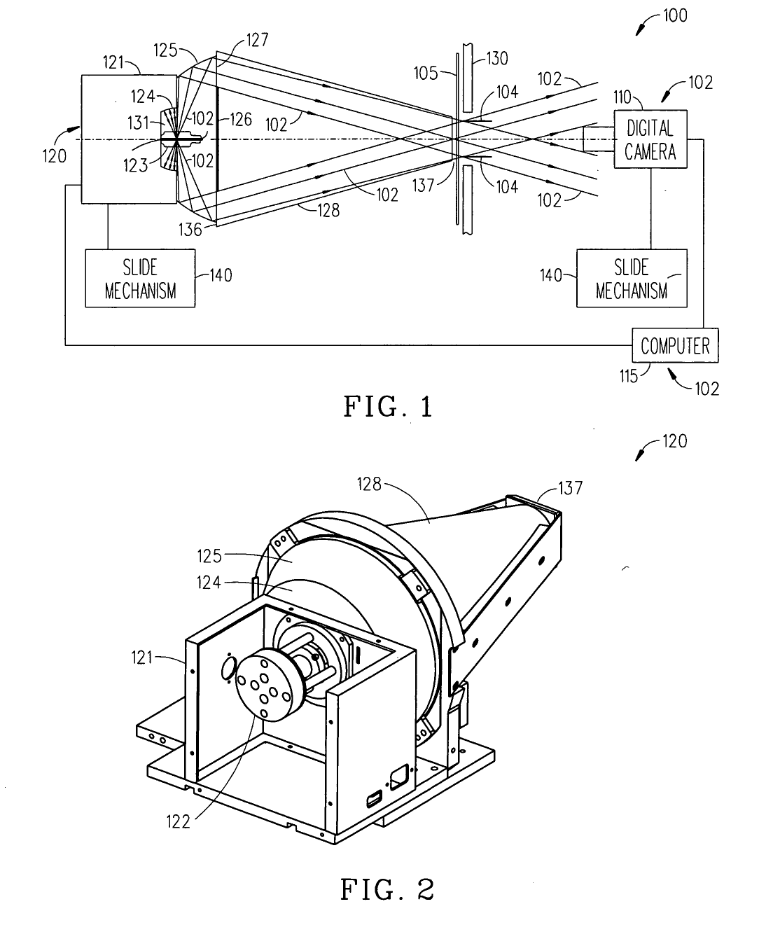

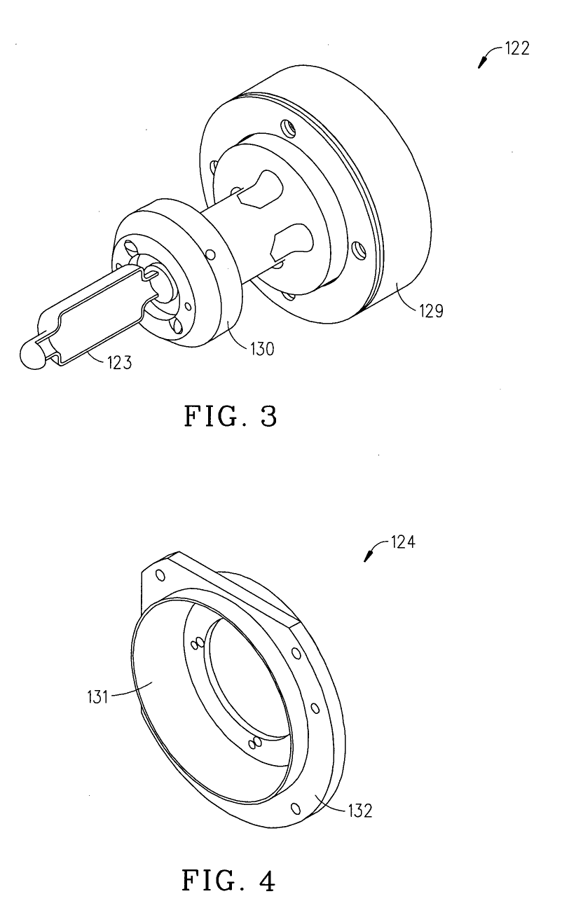

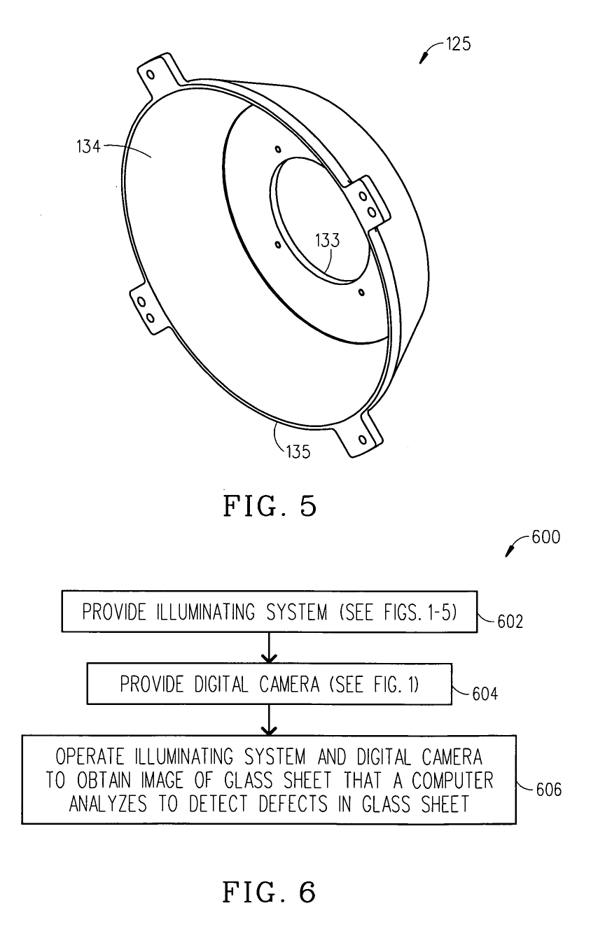

Referring to FIG. 1, there is a diagram illustrating the basic components of a preferred embodiment of an inspection system 100 in accordance with the present invention. The inspection system 100 includes an imaging system 102 (e.g., a camera 110 (e.g., digital camera 110) and a computer 115) and an illuminating system 120 that work together to identify defects (e.g., scratches, particles, air bubbles) on a surface or within a body of a glass sheet 105. In operation, the computer 115 sends trigger signals (trigger pulses) to both the illuminating system 120 and the digital camera 110 which causes the illuminating system 120 to emit light 102 that illuminates a portion 104 of the glass sheet 105 while the digital camera 110 located on the other side of the glass sheet 105 acquires an image of the illuminated portion 104 of the glass sheet 105. The computer 115 then analyzes the image acquired by the digital camera 110 to determine if there are any defects on that portion 104 of the glass sheet 105. To inspect the entire glass sheet 105, the glass sheet 105 and/or the digital camera 110/illuminating system 120 need to be moved in one way or another so that the digital camera 110 can acquire enough images to create a macro image map of the entire glass sheet 105. In one embodiment, the glass sheet 105 can be placed on an air table 130 and indexed vertically to the position of the digital camera 110 and the illuminating system 120. Then the digital camera 110 and the illuminating system 120 are both moved horizontally by a slide mechanism 140 from one side to the other side of the glass sheet 105 while the digital camera 110 is acquiring images. The glass sheet 105 is then vertically indexed by the air table 130 and this process is repeated until the entire glass sheet 105 is inspected.

As shown in FIGS. 1-5, the preferred embodiment of the illuminating system 120 includes an illuminator enclosure 121, a mounting assembly 122 (see FIG. 3), a strobe light 123, a spherical reflector 124 (see FIG. 4), a main reflector 125 (see FIG. 5), a darkfield patch 126, a diffuser 127 and a illuminator snoot 128. As described in detail below, these components 121, 122, 123, 124, 125, 126, 127 and 128 are connected to one another and function such that the strobe light 123 can radiate light 102 which is reflected and directed to a spot 104 on the glass sheet 105 that is the same or substantially the same size as the field of view of the large area scan digital camera 110. The digital camera 110 can be anyone of a wide variety of commercially available cameras like the Basler A200 Series Camera that can acquire 48 frames per second which is made by Basler Vision Technologies. The digital camera 110 can even be a CMOS digital camera 110 that can acquire 500-1000 frames per second.

The illuminator enclosure 121 houses the mounting assembly 122. The mounting assembly 122 includes a bulb stud 129 which is connected to a strobe ballast mount 130 that supports the strobe light 123 (see FIGS. 2 and 3). The strobe light 123 has a portion that is located within a cavity 131 of the spherical reflector 124 and a portion that extends out from the cavity 131 of the spherical reflector 124 (see FIGS. 1 and 4). The spherical reflector 124 has an outer rim 132 that connects to an inner wall 133 of a cavity 134 (e.g., 45° cavity 134) in the main reflector 125 (see FIG. 5). The main reflector 125 also has an outer rim 135 that connects to a large opening 136 of the illuminator snoot 128 (see FIG. 1). The diffuser 127 which has the darkfield patch 126 located thereon is secured between the main reflector 125 and the cone reflector 128 (see FIG. 1). The illuminator snoot 128 has a smaller opening 137 at the end opposite the larger opening 136.

As shown in FIGS. 1 and 2, the center of strobe light source 123 coincides with the center of the spherical reflector 124 so that light 102 reflected from the spherical reflector 124 travels through the strobe bulb envelope 123 and further reflects from the main reflector 125 along with the light 102 radiated by the strobe light 123 in the direction of the main reflector 125. The radiated and reflected light 102 is then either blocked by the darkfield patch 126 or passed through the diffuser 127 into the illuminator snoot 128 in a manner such that the diffused light 102 uniformly illuminates the desired portion/field of view 104 on the glass sheet 105. The illuminator snoot 128 blocks the portion of the light that would directly reach the camera lens without scattering on the glass defects and allows only the diffused light 102 passed through the small opening 136 reach the glass.

The diffuser 127 evenly distributes the light 102 across the entire area of small opening 137 at the end of the illuminator snoot 128. The diffuser 127 also helps to compensate for imperfections in the envelope of the strobe light 123 and in the inner surfaces of the spherical reflector 124 and the main reflector 125. In the preferred embodiment, the diffuser 127 is made from a material with minimal light absorption and the angle of diffusion has to be about maximum angle of light incidence. Micro lens array with appropriate numerical aperture might be used.

The darkfield patch 126 blocks a portion of the emitted light 102 from shining on the glass sheet 105 which enables a darkfield image to be captured by the digital camera 110. In particular, the darkfield patch 126 blocks the light 102 from going directly from the strobe light 123 to the digital camera 110. As a result in the darkfield image, a perfect glass sheet 105 is seen as a dark field. And, a non-perfect glass sheet 105 with defects such as particles on the surface or in the bulk of the glass, scratches, glass surface discontinuities, air bubbles inside the glass and other defects can be seen as bright spots in the dark field image.

The shape of the reflectors 124 and 125 are designed to take into account the characteristics of the strobe light 123. In particular, a series of equations can be solved numerically so as to optimize the output of the particular strobe light 123 from which curves are derived that are then used to design the shape of the reflectors 124, 125. In the preferred embodiment, the strobe light 123 is a Perkin Elmer X-400 strobe that has been modified to include for example the use of two red light emitting diodes (LEDs) to consistently trigger the strobe pulse. The illuminator snoot 128 can also have light absorbing inner surface which functions to decrease the glare on a lens of the digital camera 110 by absorbing the light 102 scattered by the inner surface of illuminator snoot 128 in the direction of the camera lens front element (see FIG. 1). Illuminator snoot might have other then conical shape but it should carry the opening 137.

Referring to FIG. 6, there is a flowchart illustrating the basic steps of a preferred method 600 for identifying surface and body defects in a glass sheet 105 in accordance with the present invention. Beginning at steps 602 and 604, the digital camera 110 and the illuminating system 120 are both provided and located on opposite sides of the glass sheet 105. At step 606, the digital camera 110 and the illuminating system 120 are both controlled by the computer 115 such that the illuminating system 120 operates to emit a diffused light 102 onto a portion 104 of the glass sheet 105 and the digital camera 110 operates to generate a darkfield image of that portion 104 of the glass sheet 105 which is analyzed by the computer 115 to determine whether or not there are any surface or body defects in the glass sheet 105. To inspect the entire glass sheet 105, the glass sheet 105 and/or the digital camera 110/illuminating system 120 need to be moved in one way or another so that the digital camera 110 can acquire enough images to create a macro image map of the entire glass sheet 105. In one embodiment, the glass sheet 105 can be placed on an air table 130 and indexed vertically to the position of the digital camera 110 and the illuminating system 120. Then the digital camera 110 and the illuminating system 120 are both moved horizontally by the slide mechanism 140 from one side to the other side of the glass sheet 105 while the digital camera 110 is acquiring images. The glass sheet 105 is then vertically indexed by the air table 130 and this process is repeated until the computer 115 inspects the entire area of the glass sheet 105. The types of defects that can be identified by the computer 115 include for example: (1) a particle on a surface of the glass sheet 105; (2) a particle (e.g., silica particle) inside the glass sheet 105; (3) a scratch on the surface of the glass sheet 105; (4) a discontinuity of the surface of the glass sheet 105; or (5) an air bubble inside the glass sheet 105.

From the foregoing, it can be readily appreciated by those skilled in the art that the inspection system 100 which includes an imaging system 102 (e.g., digital camera 110 and computer 115) and an illuminating system 115 (see FIGS. 2-5) can be used to inspect and identify surface and body defects in a glass sheet 105 (e.g., LCD glass substrate 105). In the preferred embodiment, the illuminating system 120 includes a strobe light 123 for emitting light 102 and a spherical reflector 124 and a main reflector 125 both of which reflect a portion of the emitted light 102. The illuminating system 120 also includes a darkfield patch 126 for blocking a portion of the emitted and reflected light 102 and a diffuser 127 for diffusing the emitted and reflected light 102 that was not blocked by the darkfield patch 126. The illuminating system 120 further includes a cone reflector 128 for containing the light 102 diffused by the diffuser 127 and directing the diffused light 102 through an opening 137 to illuminate a portion 104 of the glass sheet 105. Then, the imaging system 102 and in particular the digital camera 110 which is located on the other side of the glass sheet 105 acquires an image that is analyzed by the computer 115 to determine whether or not there is a defect in the portion 104 of the glass sheet 105.

In the preferred embodiment, the spherical reflector 124 and the main reflector 125 have mirror inner surfaces such as enhanced aluminum coating (for example) that are formed by electroforming or diamond turning and then coated to enhance reflectivity in certain spectral band. The coating can be optimized for a specific angle of incidence where for example the spherical reflector 124 is optimized for a normal angle and the main reflector 125 is optimized for 45°. It should be noted that the spherical reflector 124 is not necessary but it helps to increase light intensity in the FOV (field of view) 104 by collecting more light emitted by the strobe. Enhanced efficiency allows reducing the length and the diameter of the illuminating system 120.

In yet another embodiment, the illuminating system 120 can be operated in a brightfield mode where the darkfield patch 126 is removed and the light 102 emitted from the strobe light 123 can travel directly at and through the transparent glass sheet 105 which causes the digital camera 110 to take a brightfield image. In the brightfield mode, defects such as inclusions or scratches show up as a dark spot because the defect blocks some of the light 102. Defects that causes local changes of the glass refractive index show up as bright spots or a combination of bright and dark spots. However, it should be appreciated that an illuminating system 120 operating in a darkfield mode enables an image to be captured that has a much higher contrast and sensitivity to small defects than a brightfield image.

The inspection system 100 of the present invention uses a large area scan digital camera 110 (e.g., Basler A200 Series Digital Camera 110) and an illuminating system 120 to replace the traditional analog camera/lighting system. The digital camera 110 can have a field of view of about 30×30 mm² that effectively triples the defect scanning area and cuts the macro scan imaging time in half when compared to the traditional analog camera/lighting system. The illuminating system 120 is made up from specially designed reflectors 124 and 125, an illuminator snoot 128, a diffuser 127 and a dark field patch 126. The reflectors 124, 125, illuminator snoot 128 are unique in that they are designed around the light source of a particular strobe light 123 so as to provide uniform illumination of the intended field of view and to minimize loss of strobe light 123. Below are listed some exemplary advantages of the present invention:
1) Provides adequate light intensity and uniformity necessary to obtain accurate darkfield images of the defects in the glass sheet 105.
2) Effectively triples the field of view over the traditional inspection system which in turn reduces the time to inspect the glass sheet 105.
3) Reduces the power required to run the strobe light 123 which increases life of the strobe light 123.
4) Eliminates the need to use costly, short life, fiber bundles.
5) Allows a compact illuminator design when compared with traditional condenser optics that have the same field of view.

Although one embodiment of the present invention has been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

What is claimed is:

1. An inspection system for identifying defects in a glass sheet, comprising:
a camera; and
an illuminating system including:
a strobe light for emitting light;
a main reflector for reflecting a portion of the emitted light;
a diffuser for spreading the emitted light and the reflected light across a portion of the glass sheet; and
said camera located on one side of the glass sheet generates an image that indicates whether or not there is a defect in the portion of the glass sheet that is illuminated by the diffused light emitted from said illuminating system which is located on an opposite side of the glass sheet.

2. The inspection system of claim 1, further comprising:
a moving device for moving the glass sheet; and
a sliding device for moving said camera and said illuminating system so that said camera can generate a plurality of images to create a macro image map of the glass sheet.

3. The inspection system of claim 1, wherein said camera is a digital camera.

4. The inspection system of claim 1, wherein said illuminating system includes an illuminator snoot for eliminating glare in the camera objective by blocking the portion of the light from reaching the camera lens without scattering on the glass defects.

5. The inspection system of claim 1, wherein said illuminating system includes a spherical reflector for directing a portion of the light emitted from said strobe light to said main reflector and said diffuser.

6. The inspection system of claim 1, wherein said illuminating system further includes a darkfield patch for blocking a portion of the light emitted from said strobe light so that said camera can generate a darkfield image of the portion of the glass sheet.

7. The inspection system of claim 1, wherein said defect includes:
a particle on a surface of the glass sheet;
a particle inside the glass sheet;
a scratch on the surface of the glass sheet;
a discontinuity of the surface of the glass sheet; or
an air bubble inside the glass sheet;
a local deviation of refractive index of the glass known as micro lens or silica inclusion.

8. A method for identifying defects in a glass sheet, comprising:
providing an imaging system including a camera and a computer;
providing an illuminating system that includes:
a strobe light for emitting light;
a main reflector for reflecting a portion of the emitted light;
a diffuser for spreading the emitted light and the reflected light across a portion of the glass sheet; and
operating said camera and said illuminating system such that said camera which is located on one side of the glass sheet can generate an image which is analyzed by said computer to determine whether or not there is a defect in the portion of the glass sheet that is illuminated by the diffused light emitted from said illuminating system which is located on an opposite side of the glass sheet than said camera.

9. The method of claim 8, further comprising the step of moving the glass sheet so that said camera can generate a plurality of images to create a macro image map of the glass sheet.

10. The method of claim 8, wherein said camera is a digital camera.

11. The method of claim 8, wherein said illuminating system includes a spherical reflector for directing a portion of the light emitted from said strobe light to said main reflector and said diffuser.

12. The method of claim 8, wherein said illuminating system further includes a darkfield patch for blocking a portion of the light emitted from said strobe light so that said camera can generate a darkfield image of the portion of the glass sheet.

13. The method of claim 8, wherein said defect includes:
a particle on a surface of the glass sheet;
a particle inside the glass sheet;
a scratch on the surface of the glass sheet;
a discontinuity of the surface of the glass sheet; or
an air bubble inside the glass sheet.
a local deviation of refractive index of the glass known as micro lens or silica inclusion.

14. An illuminating system used to identify defects in a glass sheet, comprising:
a strobe light for emitting light;
a main reflector for reflecting a portion of the emitted light; and
a diffuser for spreading the emitted light and the reflected light across a portion of the glass sheet, wherein a camera located on one side of the glass sheet generates an image that indicates whether or not if there is a defect in the portion of the glass sheet that is illuminated by the diffused light which passed through said diffuser which is located on an opposite side of the glass sheet.

15. The illuminating system of claim 14, further comprising an illuminator snoot for eliminating glare in the camera objective by blocking the portion of the light from reaching the camera lens without scattering on the glass defects.

16. The illuminating system of claim 14, further comprising a spherical reflector for directing a portion of the light emitted from said strobe light to said main reflector and said diffuser.

17. The illuminating system of claim 14, further comprising a darkfield patch for blocking a portion of the light emitted from said strobe light so that said camera can generate a darkfield image of the portion of the glass sheet.

18. The illuminating system of claim 14, wherein said defect includes:
a particle on a surface of the glass sheet;
a particle inside the glass sheet;
a scratch on the surface of the glass sheet;
a discontinuity of the surface of the glass sheet; or
an air bubble inside the glass sheet;
a local deviation of refractive index of the glass known as micro lens or silica inclusion.

19. An inspection system for identifying defects in a glass sheet, comprising:
a digital camera; and
an illuminating system including:
a strobe light for emitting light;
a main reflector for reflecting a portion of the emitted light;
a spherical reflector for reflecting a portion of the emitted light;
a darkfield patch for blocking a portion of the emitted light and the reflected light;
a diffuser for diffusing the emitted light and the reflected light that was not blocked by said darkfield patch;
an illuminator snoot for eliminating glare in the camera objective by blocking the portion of the light from reaching the camera lens without scattering on the glass defects; and
said digital camera located on one side of the glass sheet generates a darkfield image that indicates whether or not if there is a defect in the portion of the glass sheet that is illuminated by the diffused light emitted from said illuminating system located on an opposite side of the glass sheet.

20. The inspection system of claim 19, further comprising:
a moving device for moving the glass sheet; and
a sliding device for moving said digital camera and said illuminating system so that said digital camera can acquire a plurality of darkfield images to create a macro image map of the glass sheet.
